(19) United States
(12) Patent Application Publication
(10) Pub. No.: US 2005/0115658 A1
(43) Pub. Date: Jun. 2, 2005

(54) Joining of ceramic powder pressed components in the green or sintered state with a gelcast joint

(76) Inventors: Amit K. Daga, Gainesville, FL (US); Wolfgang M. Sigmund, Gainesville, FL (US)

Correspondence Address: AKERMAN SENTERFITT, P.O. BOX 3188, WEST PALM BEACH, FL, 33402-3188, US

(21) Appl. No.: 10/980,997

(22) Filed: Nov. 4, 2004

Related U.S. Application Data
(60) Provisional application No. 60/517,478, filed on Nov. 4, 2003.

(51) Int. Cl. C03B 29/00

(52) U.S. Cl. 156/89.11; 156/89.16

(57) ABSTRACT

A method of joining components includes the steps of providing a slurry including a solvent, a ceramic, metal or cermet powder and at least one binder selected from natural monomers or cross linkable polymer compositions. The binder is crosslinked to form a gel. The gel is then placed between the first and at least a second component to be joined. The gel is then sintered to form an article having a gelcast joint binding the first and second components. The resulting joint region will generally have the same strength as the first and second components.

### CROSS-REFERENCE TO RELATED APPLICATIONS

This application claims the benefit of U.S. Provisional Application No. 60/517,478 entitled “Joining Of Ceramic Powder Pressed Components In The Green Or Sintered State With a Gelcast Joint” filed on Nov. 4, 2003, the entirety of which is incorporated herein by reference.

### STATEMENT REGARDING FEDERALLY SPONSORED RESEARCH OR DEVELOPMENT

Not applicable.

### FIELD OF THE INVENTION

The invention relates to methods of joining ceramic or cermet components, more specifically joining such components using gelcasting, and related articles therefrom.

### BACKGROUND OF THE INVENTION

Methods for forming ceramic powders into complex shapes are desirable in many areas of technology. For example, such methods are required for producing advanced, high temperature structural parts such as heat engine components and recuperators from ceramic powders. Generally, two methods are presently known for forming ceramic powders into complex or intricately shaped parts. One method comprises machining a green blank to the desired shape. However, this method has significant drawbacks in that the machining is time consuming, expensive, and generally inapplicable to some complex or varied cross-sectional shapes, for example, turbine rotors. A second method for forming ceramic powders into complex or intricately shaped parts comprises injection molding a composition which comprises the ceramic powder and a polymeric and/or waxlike binder as a vehicle for the ceramic powder. Polymers have been demonstrated to have utility in methods of forming complex or intricately shaped parts from ceramic powders. The forming of ceramics is important because machining ceramics into complex shapes is time consuming and expensive, and in many cases impractical.

It is known that gelcasting can also be a useful way of forming ceramic materials. Gelcasting is a method of molding ceramic powders into green products wherein a monomer solution is used as a binder and the controlled polymerization of the monomer in solution serves as a setting mechanism. The resulting green product can be of exceptionally high strength and may be dried to remove water or other solvent. After drying, the product may be further heated to remove the polymer and may also subsequently be fired to sinter the product to a high density. Gelcasting methods are disclosed in Janney, U.S. Pat. No. 4,894,194, Janney et al, U.S. Pat. No. 5,028,362, and Janney et al., U.S. Pat. No. 5,145,908. The disclosures of these references are incorporated fully by reference. Although Janney discloses gelcasting methods, Janney does not disclose methods for joining components using a gelcast joint.

### SUMMARY OF THE INVENTION

A method of joining components includes the steps of providing a slurry including a solvent, a ceramic, metal or cermet powder, and at least one binder selected from natural monomers or cross linkable polymer compositions. The binder is crosslinked to form a gel. The gel is then placed between the first and at least a second component to be joined. The gel is then sintered to form an article having a gelcast joint binding the first and second components. The resulting joint region can have about the same strength as the first and second components.

In one embodiment, at least one of the first and second components is in a green state prior to the sintering step. The first and second components can also be pre-sintered components. In another embodiment, no applied pressure is used during the sintering step. The first and/or second components can comprise ceramic materials, where the ceramic powder comprises the ceramic material. The first and/or second components can also comprise cermets. The powder: can be a ceramic powder and the slurry can be metal-free.

The slurry can include a dispersant. The slurry can comprise at least 50 vol % of the powder. The powder can be alumina, fused silica, magnesia, zirconia, spinels, mullite, glass frits, tungsten carbide, silicon carbide, boron nitride and silicon nitride powders, and mixtures thereof.

The binder can be cellulose-based, or include gelatin or carrageenan. Crosslinking can occurs without the presence of any cross linkers.

A ceramic comprising article comprises a first ceramic comprising portion, at least a second ceramic comprising portion, and a joint region binding the first ceramic comprising portion to the second ceramic comprising portion. The joint region includes a ceramic composition, wherein a bulk region of at least one of the first and second ceramic components includes the ceramic composition. The ceramic comprising components can be cermets.

### BRIEF DESCRIPTION OF THE DRAWINGS

A fuller understanding of the present invention and the features and benefits thereof will be accomplished upon review of the following detailed description together with the accompanying drawings, in which:

FIG. 1 shows the viscosity of a gelcast gelatin slurry including 50 vol. % alumina powder as a function of temperature at a shear rate of 100s⁻¹, according to an embodiment of the invention.

FIG. 2 shows the scanned green microstructure of a gelcast gelatin joint described relative to FIG. 1.

FIG. 3 shows the scanned sintered microstructure of the gelcast joint formed by sintering the green joint shown in FIG. 2.

FIG. 4 shows a scanned photograph of a powder pressed aluminum part including a gel cast joint material, according to another embodiment of the invention.

FIG. 5 shows the Weibull Distribution obtained for the gelcast joint sample shown in FIG. 3.

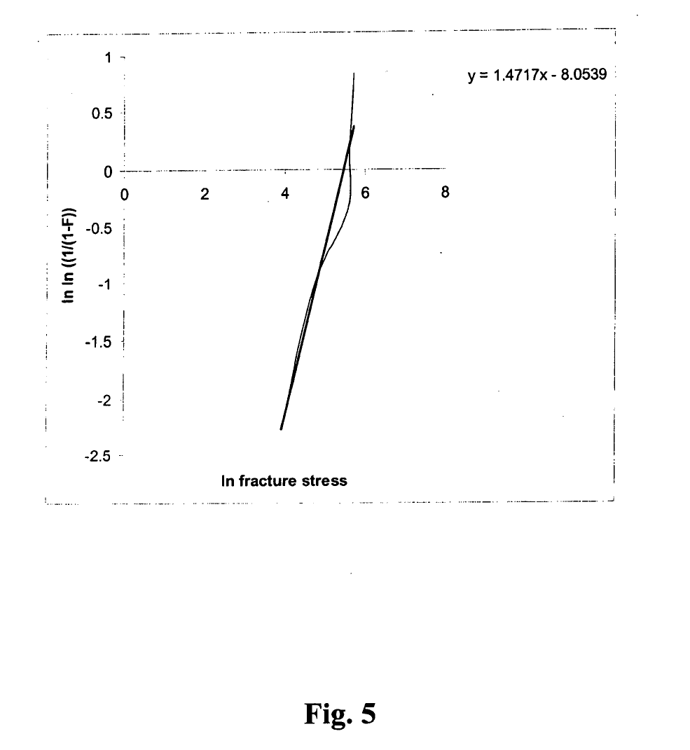

FIG. 6 shows the shear rate dependence of shear stress and shear viscosity with variation of % tri-ammonium citrate (TAC) powder.

FIG. 7 shows the viscosity of the 40 vol % mullite slurry measured as a function of TAC concentration at a shear rate of 103 s⁻¹.

FIG. 8 shows the viscosity of the mullite slurry as a function of temperature at 0.1 and 0.9 wt % TAC dosages.

### DETAILED DESCRIPTION

A method of joining components includes the steps of providing a slurry including a solvent, a ceramic, metal or cermet powder, and at least one binder. The binder comprises a natural monomer or cross linkable polymer composition. The ceramic or cermet powder is suspended and dispersed in the solvent, such as water. Cermets refer to any of several materials consisting of a metal matrix with ceramic particles disseminated throughout. Although water is generally used as the solvent, in certain applications such as for aluminum nitride or other water sensitive powders, an organic solvent can be used.

To aid in the dispersion, the slurry preferably includes at least one dispersant. Alternatively, or in addition, steric, electrostatic and electrosteric stabilization techniques can be used for dispersion of the powder. A ball milling or equivalent treatment is preferably used to break up generally undesirable powder agglomerates in the slurry. The removal of agglomerates leads to optimal particle packing and the ability to obtain highly homogenous and dense green joints.

The binder in the slurry is then crosslinked to form a gel comprising the respective slurry components. A cross linking agent is not generally required to cross link binders according to the invention. The gel is placed between the first and at least a second component to be joined. The gel is then sintered to remove the organics and solvent to provide an article having a gelcast joint binding these components. The process is low cost, environmental benign, and can produce joints having strengths which approach the strength in the bulk portions of the respective components joined.

If the component materials to be joined are mechanically substantially dissimilar, then the resulting joint strength depends on the material selected to join the components. If the joint material is based on the lower mechanical property material, then the joint strength will generally be less than the strength in the bulk of the higher mechanical strength material. If the joint material is based on the higher mechanical strength material, the joint strength can exceed the strength in the bulk portion of the mechanically weaker component and approach the strength in the bulk portion of the mechanically stronger component.

The components to be joined can be in the green state, or can be sintered components. Alternatively, one component can be in the green state and one component can be a sintered component. Joining of sintered components is a surprising result since unlike green state components, sintered components generally lack an significant porosity. Although generally described relative to ceramics, one or more of the components to be joined can be a cermets.

The slurry can comprise 30 to 80 vol. % powder, but preferably comprises at least 50 vol. % of the powder, such as 50, 55, 60, 65 or 70 vol. % powder. The ceramic powder can be selected from alumina, fused silica, magnesia, zirconia, spinels, mullite, glass frits, tungsten carbide, silicon carbide, boron nitride and silicon nitride powders, and mixtures thereof. Cermet, powders can include tungsten carbide cobalt, titanium nitride, and boron carbide. Cermets can be formed by mixing a metal powder, a ceramic powder, a solvent and a binder according to the invention, with cermet particles formed after sintering.

Unlike conventional gelcasting slurries which include cross linkers and evironmentally harmful components, using the binders described herein, cross linkers are generally not required to gel the binder. In addition, the slurry components are all generally environmentally safe. Moreover, gelation can generally occur at room temperature.

The binder can be a protein based natural material capable of gelation, such as gelatin, carrageenan, other polysaccharide based polymers or a cellulose based polymer binder. As with gelatin or carrageenan, most cellulose-based binders will readily gelate in water at room temperature. Carrageenan is a natural gum extracted from abundant seaweeds. Protein mixtures may also be used, such as gelatin. Gelatin is a protein comprising substance obtained from the boiling of bones and connective tissue. The bones and connective tissue are generally obtained from the meat industry. Gelatin powder is about 85% protein, 13% water and 2% mineral salts and contains protein polymers comprising about 18 different amino acids joined in long polymer chains. By simply adding a solvent such as water, the protein molecules crosslink to form triple helix or triple spirals which gels the slurry material.

Following application of the gel to the region to be bound, the gel is then sintered to remove the organics and solvent to provide an article having a gelcast joint binding these components. Typically sintering temperatures generally range form 500° C. to 2000° C. depending on the material being processed. Sintering times can range from 1 to 5 hours in air, vacuum or hydrogen environments. One advantage of the invention is that sintering can generally proceed without applied pressure which is typically required for conventional ceramic joining processes.

In a preferred embodiment of the invention, at least one of the components to be joined include the same ceramic or cermet material as in the ceramic powder used to form the slurry. Advantages of this match include thermal matching of the joint and parent bulk materials, and formation of a joint which can withstand corrosive environments.

The invention is expected to have a wide range of applications as it can be used to inexpensively fabricate simple or complex articles. Significantly, the invention can lower fabrication expenses by making complex shaped components from simple shaped components, thus avoiding costly machining and grinding procedures. Since joining can be performed without generally applying pressure in the sintering/firing step, pressurizing equipment can be eliminated and more complex shapes can be formed.

The applications can include a wide range of industries such as structural uses. In addition, the invention can be used to form natural or synthetic bone materials, such as for medical implants. Another exemplary application of the invention is to form composites for turbine blades.

### EXAMPLES

The present invention is further illustrated by the following specific Examples, which should not be construed as limiting the scope or content of the invention in any way.

### Example 1

Alumina-based System Joining

When formulating an alumina-based slurry it was found to be important to have relatively high solid loading to minimize shrinking during sintering processes and amount of porosity later found in the resulting gelcast joint. Larger shrinkage may induce residual stress while porosity may act as stress concentrators, both of which can substantially reduce the strength of the gelcast joint.

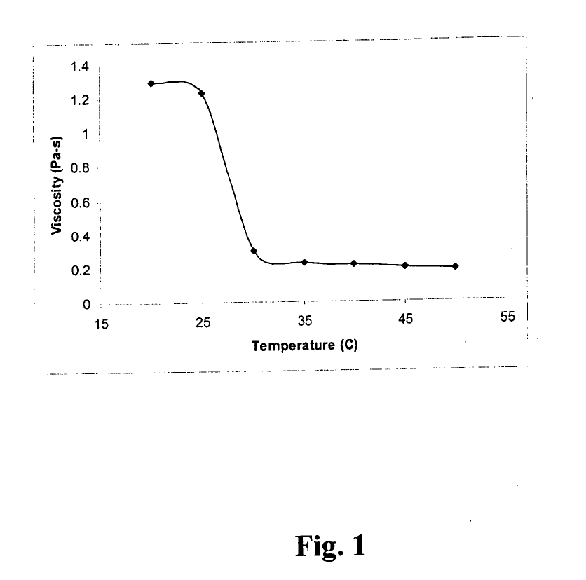

A gelcast slurry was prepared with a 50% volume alumina powder loading. It was determined that a colloidally stable aqueous alumina slurry could be dispersed with 0.4 wt % tri-ammonium citrate dispersant. Proper dispersion of the slurry is necessary in order to prevent agglomerate formation, which can lead to the creation of voids in the gelcast joint. After proper mixing in a planetary ball mill, 1 wt % gelatin with several milliliters of octanol was introduced to the warmed (50° C.) slurry. After further mixing, the gelatin became dissolved and the slurry deaired. Deairing is generally needed to remove bubbles formed during the mixing processes. Deairing was done in a vacuum environment, but can be opposed by viscous drag of the slurry. FIG. 1 shows the viscosity of the resulting gelatin gelcast slurry as a function of temperature at a shear rate of 100s⁻¹. As the temperature falls below about 30° C., the viscosity is seen to begin to rapidly rise from a nearly constant at a low level (about 0.2 Pa-s).

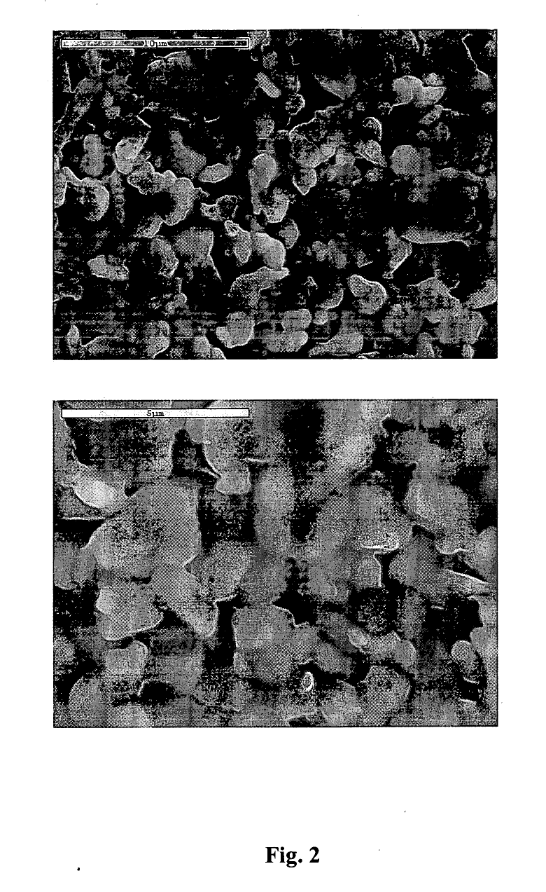

Deairing is generally successful only if the viscosity of the slurry is low. Therefore deairing was performed at 40° C. After deairing was completed, the gelcast joint material slurry was ready to be applied to green pressed ceramic components. FIG. 2 shows a scanned green microstructure of the gelcast joint material. The scanned micrograph shows that the gelcast joint material is highly dense, making it well suited for joining applications.

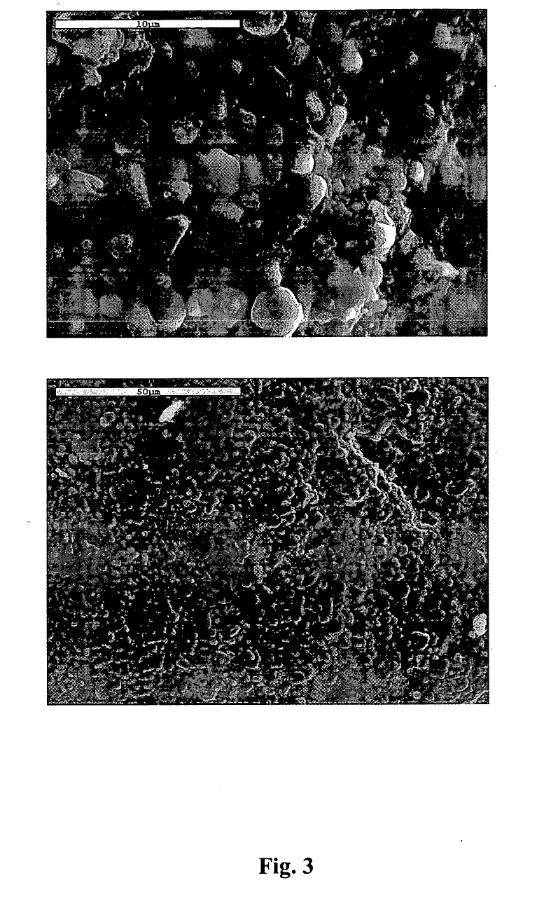

The green ceramic components joined by the gelcast joint material were then sintered at 1600° C. in an air atmosphere for 2 hours. FIG. 3 shows a scanned sintered microstructure of the gelcast joint shown in FIG. 2. The scanned micrograph shows that the gelcast joint material retains its highly dense form upon sintering.

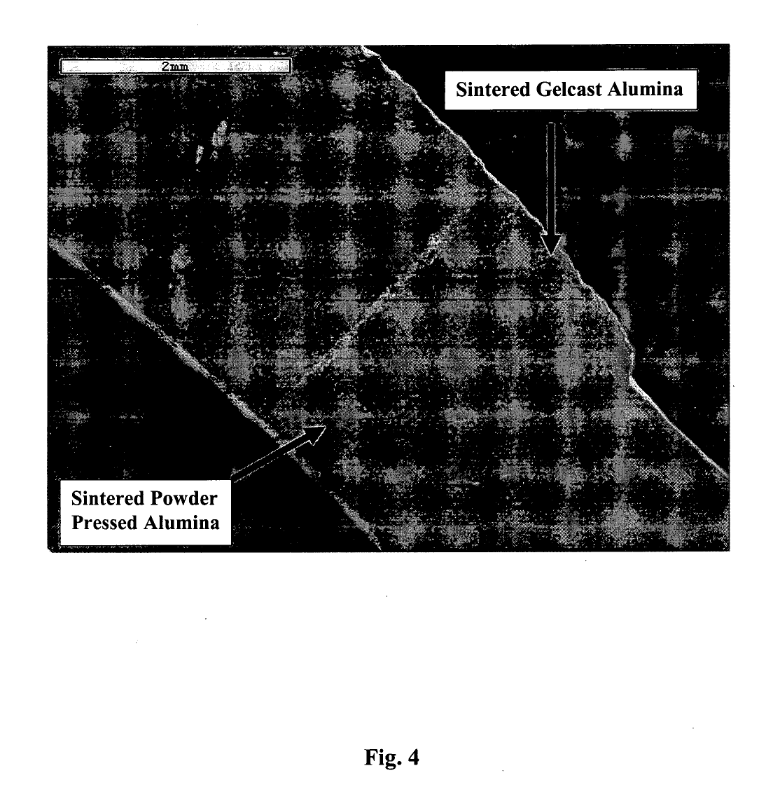

The fracture strengths of the sintered samples were measured in four point bending. A measured fracture strength value was 306 MPa. FIG. 4 shows the Weibull analysis of the fracture strengths measured. The calculated Weibull modulus is 1.47, which indicates that the spread in the data is somewhat high. Careful control of the gelcast slurry can be used to improve the spread.

### Example 2

Mullite-based System Joining

In this Example, tri-ammonium citrate (TAC) as a dispersant and polyacrylic acid (PAA) as a gelling agent were used together with 40 vol % mullite powder to form a gelcast slurry. The optimum dosage of the TAC powder was determined by rheological measurement for series mullite suspensions with variation in TAC amount. This was assumed to be the optimum amount being just enough to yield a suspension with minimum shear viscosity at a fixed shear rate. The dosage of PAA was set as 0.04% in weight of the dry mullite powder to compare with the AKP53 alumina ceramic system.

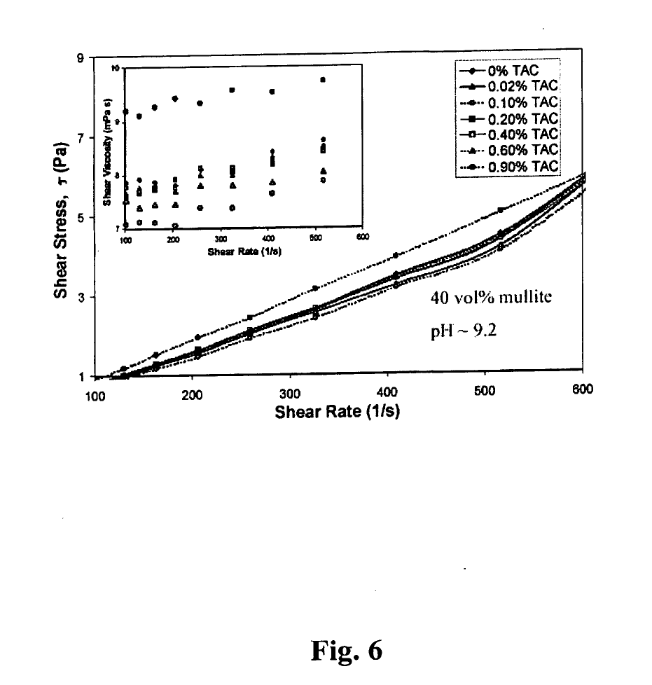

The mullite suspensions containing both TAC and PAA were prepared by a two-step method. The first step was to mix the designed amount of mullite powder, TAC powder and respective amount of water in a planetary ball mill. It was found that the dosage amount of TAC is an important parameter to control the room-temperature viscosity of the as prepared suspension. In order to get a minimum viscosity value in a suspension, it was found to require that the particle surface have a full coverage of the dispersant molecules so as to give a maximum surface charge, and a consequent maximum zeta potential to result in a maximum repulsive force between the dispersed particles, where electric-double-layer (EDL) stabilization takes effect. The overdose of the dispersant TAC was found to generate viscous resistance and therefore increase the viscosity of the suspension under shear. By measuring the viscosity of a suspension with fixed solid volume fraction while varying the dosage amount of the TAC dispersant, the optimum dosage of TAC was determined. FIG. 6 shows the shear rate dependence of shear stress and shear viscosity with variation of TAC amount for 40 vol % mullite suspensions at a pH of 9.2.

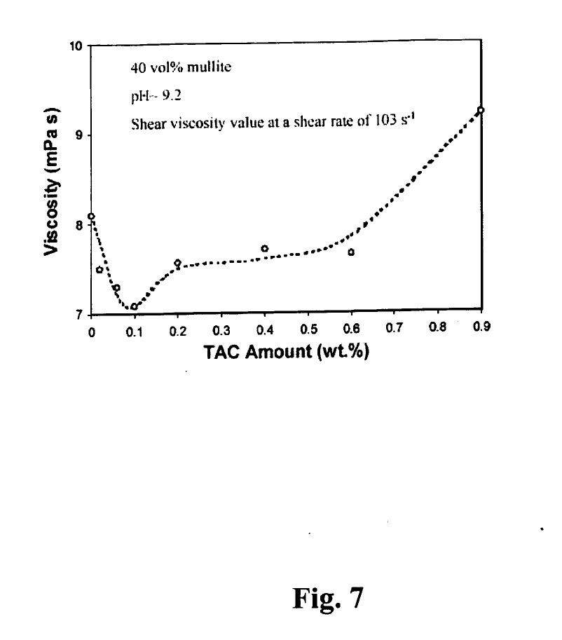

Both the shear-thinning at low shear rate range and the shear-thickening behaviors at higher shear rate range were observed for all suspensions, which indicates changes of the suspension microstructure under shear. FIG. 7 shows the viscosity of the 40 vol % mullite slurry measured as a function of TAC concentration at a shear rate of 103 s⁻¹.

The suspension viscosity decreases with the amount of TAC first; and a dosage of about 0.1 wt % TAC yields the lowest viscosity value and is thus the optimum dosage amount found for 40 vol % mullite suspensions. With more TAC addition, the viscosity of the suspensions starts to increase gradually, where the excessive TAC molecules in the suspension contributes more resistance to the movement of water molecules under shear. From these results, it was concluded that the optimum dosage amount of TAC is about 0.1 wt %.

The pH was then adjusted to 9.4 with ammonium hydroxide before adding the exact amount of PAA. The second step is to add the gelling agent PAA into the suspension. After adding 0.04 wt % PAA, the suspensions were ball-milled to get the final suspensions. The pH value of the final suspension was about 9.2, which is far away from the isoelectric point (˜pH 4) of the mullite suspensions containing TAC.

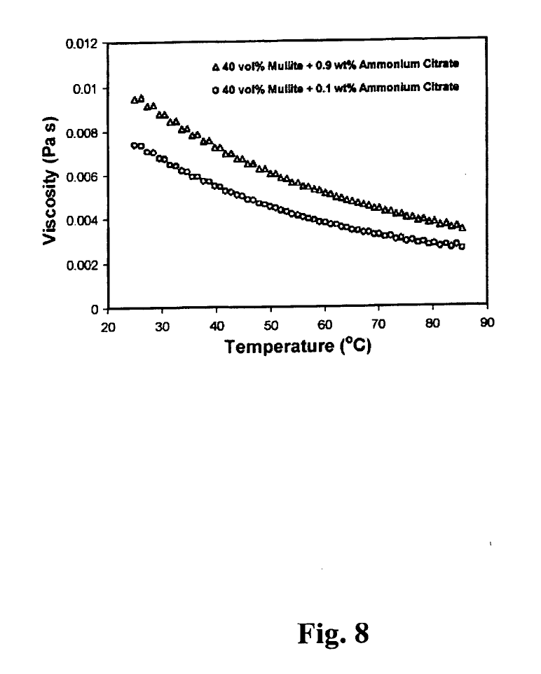

FIG. 8 shows the viscosity of the mullite slurry as a function of temperature at 0.1 and 0.9 wt % TAC dosages. With mullite suspensions with only TAC dosage (no gelation agent), it can be seen that their shear viscosity did not increase, but rather decreased with temperature.

Both the 40 vol % mullite suspensions with 0.1 and 0.9 wt % TAC dosage were found to decrease their shear viscosity monotonously with increasing temperature, which can be attributed to the decreasing of the shear viscosity of water with temperature. The decreasing of shear viscosity also indicates that no observed gelation will occur in such suspensions at elevated temperatures, therefore, it is generally required that a gelling agent be added to alter the rheological behavior of the suspension.

Further improvements in joining of ceramic powder pressed components in the green state can improve performance of the invention and can be accomplished based on improving removal of bubbles during processing. In addition, higher solids loading, such as 70-80% or more, can minimize shrinkage and porosity.

It should be understood that the examples and embodiments described herein are for illustrative purposes only and that various modifications or changes in light thereof will be suggested to persons skilled in the art and are to be included within the spirit and purview of this application. The invention can take other specific forms without departing from the spirit or essential attributes thereof.

1. A method of joining components, comprising the steps of:
providing a slurry including a solvent, a ceramic, metal or cermet powder and at least one binder selected from natural monomers or cross linkable polymer compositions;
crosslinking said binder to form a gel;
placing said gel between a first and at least a second component to be joined, and
sintering said gel to form an article having a gelcast joint binding said first and second components.

2. The method of claim 1, wherein said slurry further includes a dispersant.

3. The method of claim 1, wherein at least one of said first and second components is in a green state prior to said sintering step.

4. The method of claim 1, wherein at least one of said first and second components comprises a ceramic material, said ceramic powder comprising said ceramic material.

5. The method of claim 1, wherein no applied pressure is used during said sintering step.

6. The method of claim 1, said slurry comprises at least 50 vol % of said powder.

7. The method of claim 1, wherein said powder is selected from the group consisting of alumina, fused silica, magnesia, zirconia, spinels, mullite, glass frits, tungsten carbide, silicon carbide, boron nitride and silicon nitride powders, and mixtures thereof.

8. The method of claim 1, wherein at least one of said first and second components comprise cermets.

9. The method of claim 1, wherein at least one of said first and second components are sintered components.

10. The method of claim 1, wherein said binder is cellulose-based, gelatin or carrageenan.

11. The method of claim 1, wherein said crosslinking occurs without the presence of any cross linkers.

12. The method of claim 1, wherein said powder is a ceramic powder and said slurry is metal-free.

13. A ceramic comprising article, comprising:
a first ceramic comprising portion;
at least a second ceramic comprising portion, and
a joint region binding said first ceramic comprising portion to said second ceramic comprising portion, said joint region including a ceramic composition, wherein a bulk region of at least one of said first and second ceramic components includes said ceramic composition.

14. The article of claim 13, wherein at least one of said first and second ceramic comprising portions are cermets.
